(19) United States
(12) Patent Application Publication
(10) Pub. No.: US 2015/0196846 A1
(43) Pub. Date: Jul. 16, 2015

(54) INTERACTIVE SYSTEM AND INTERACTIVE METHOD

(71) Applicant: Quanta Computer Inc., Kuei Shan Hsiang (TW)

(72) Inventors: Yu-Liang Shih, Kuei Shan Hsiang (TW); Jung-Wen Chang, Kuei Shan Hsiang (TW); Yi-Pin Huang, Kuei Shan Hsiang (TW)

(73) Assignee: Quanta Computer Inc., Kuei Shan Hsiang (TW)

(21) Appl. No.: 14/219,539

(22) Filed: Mar. 19, 2014

(30) Foreign Application Priority Data
Jan. 13, 2014 (TW) 103101113

(51) Int. Cl. A63F 13/818; G06F 3/0481; A63F 13/73; H04L 29/06

(52) U.S. Cl. CPC A63F 13/818; H04L 63/08; G06F 3/04815; A63F 13/73

(57) ABSTRACT

An interactive system includes a tag and an electronic device. The tag is movable by a user. The electronic device includes a camera module, a display device, and a processor. The camera module detects the tag and obtains tag information. The processor controls the display device to display a first virtual object and a second virtual object according to the tag information. The first virtual object moves to follow the movement of the tag. The processor further controls the display device to display a corresponding image according the relative positions of the first virtual object and the second virtual object.

### CROSS REFERENCE TO RELATED APPLICATIONS

This Application claims priority of Taiwan Patent Application No. 103101113 filed on Jan. 13, 2014, the entirety of which is incorporated by reference herein.

### BACKGROUND OF THE INVENTION

1. Field of the Invention

The disclosure generally relates to an interactive system, and more particularly to an interactive system combining an electronic device with an entity.

2. Description of the Related Art

With the rapid development of technology, a variety of electronic devices play an important role in people's lives. The most popular one is the electronic device that can interact with people. Interactive electronic devices could be applied in many aspects of daily life, such as entertainment, education, or a combination thereof.

However, current interactive electronic devices either lack a realistic sense or have a high price. There is a need to design a low-cost, highly realistic interactive system to meet the requirements of users.

### BRIEF SUMMARY OF THE INVENTION

In one exemplary embodiment, the disclosure is directed to an interactive system, which includes a tag and an electronic device, for interaction with a user. The tag is movable by the user. The electronic device includes a camera module, a display device, and a processor. The camera module detects the tag and obtains tag information. The processor controls the display device to display a first virtual object and a second virtual object according to the tag information. The first virtual object moves to follow the movement of the tag. The processor further controls the display device to display a corresponding image according the relative positions of the first virtual object and the second virtual object.

In another exemplary embodiment, the disclosure is directed to an interactive method for interaction with a user, including the steps of: detecting a tag and obtaining tag information via a camera module, wherein the tag is movable by the user; controlling a display device to display a first virtual object and a second virtual object according to the tag information, wherein the first virtual object moves to follow a movement of the tag; and controlling the display device to display a corresponding image according to relative positions of the first virtual object and the second virtual object.

### BRIEF DESCRIPTION OF DRAWINGS

The invention can be more fully understood by reading the subsequent detailed description and examples with references made to the accompanying drawings, wherein:

FIG. 1 shows a diagram of an interactive system according to an embodiment of the invention;

FIG. 2 shows a diagram of an interactive system according to an embodiment of the invention;

FIG. 3 shows a diagram of an interactive system according to an embodiment of the invention;

FIG. 4 shows a diagram of an interactive system according to an embodiment of the invention;

FIG. 5 shows a diagram of an interactive system according to an embodiment of the invention; and

FIG. 6 shows a flowchart of an interactive method according to an embodiment of the invention.

### DETAILED DESCRIPTION OF THE INVENTION

In order to illustrate the purposes, features and advantages of the invention, the embodiments and figures of the invention are described in detail as follows.

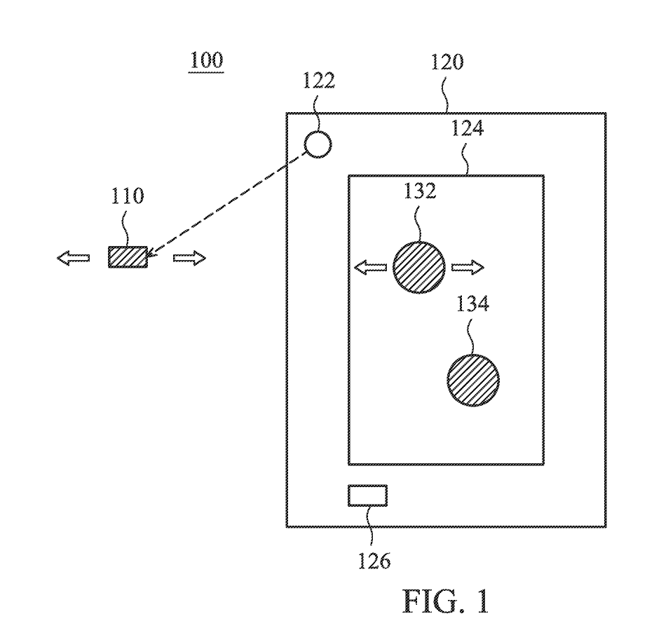

FIG. 1 shows a diagram of an interactive system 100 according to an embodiment of the invention. As shown in FIG. 1, the interactive system 100 at least includes a tag 110 and an electronic device 120. With the interactive system 100, a user can interact with the electronic device 120 by moving the tag 110. In some embodiments, the tag 110 includes a pattern, a two-dimensional barcode, a QR code (Quick Response Code), or any combination thereof, such as a two-dimensional barcode embedded in a pattern. The electronic device 120 may be a mobile device, such as a smartphone, a tablet computer, or a laptop computer. The electronic device 120 at least includes a camera module 122, a display device 124, and a processor 126. It is understood that the positions of the aforementioned elements on the electronic device 120 are just exemplary and not limitations of the invention. The electronic device 120 may further include other elements, such as a battery, a frame, a wireless communication module, and a speaker (not shown). When the user moves the tag 110 into the detectable range of the camera module 122, the camera module 122 detects the tag 110 (e.g., by identifying a pattern of the tag 110, or by reading a two-dimensional barcode or a QR code of the tag 110) and obtains tag information. The tag information may include pattern information of the tag 110, identification code information of the two-dimensional code or the QR code, three-dimensional coordinates of the tag 110, and/or the movement of the tag 110. The processor 126 controls the display device 124 to display a first virtual object 132 and a second virtual object 134 according to the tag information. In some embodiments, the first virtual object 132 moves to follow the movement of the tag 110 (i.e. the movement of the first virtual object 132 is relative to the movement of the second virtual object 134). For example, if the tag 110 moves leftward by a first distance, the first virtual object 132 on the display device 124 will move leftward by a second distance which is in proportion to the first distance.

In some embodiments, the processor 126 executes a software program for converting three-dimensional vector coordinates into two-dimensional vector coordinates so as to achieve the above display effect. That is, three-dimensional vector coordinates are projected onto two-dimensional vector coordinates, and then they are converted into corresponding positions on the display device 124. Furthermore, the processor 126 can control the display device 124 to display a variety of corresponding images according to the relative positions of the first virtual object 132 and the second virtual object 134. This will be described in detail in the following embodiments.

In some embodiments, the camera module 122 is disposed opposite to the display device 124. In other words, the camera module 122 and the display device 124 are disposed on a front surface and a back surface of the electronic device 120, respectively.

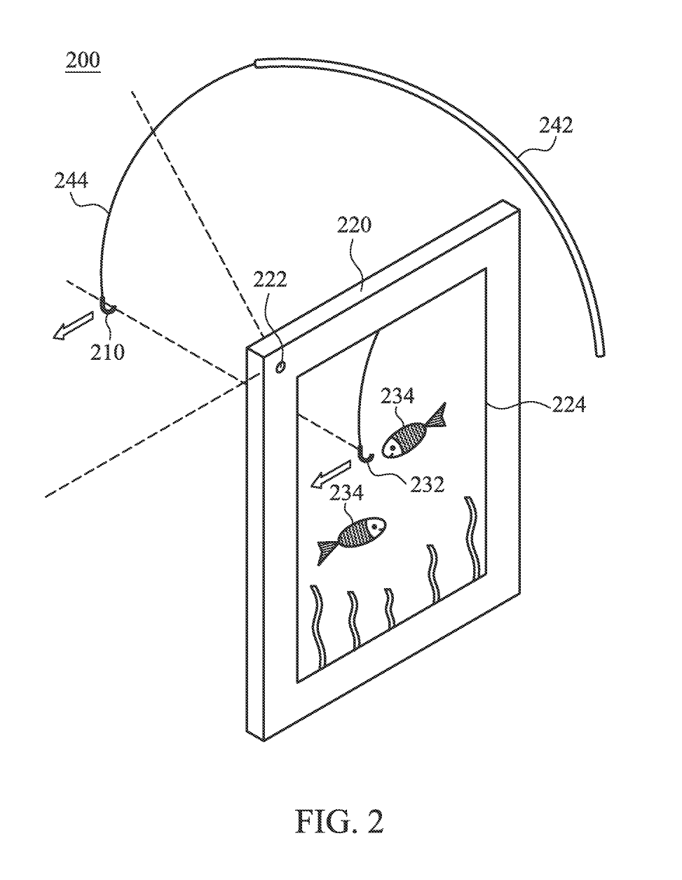

FIG. 2 shows a diagram of an interactive system 200 according to an embodiment of the invention. In the embodiment of FIG. 2, the interactive system 200 includes a tag 210, an electronic device 220, a fishing rod 242, and a thin line 244. The functions of the tag 210 and the electronic device 220 are similar to those described in the embodiment of FIG. 1. The electronic device 220 may store a fishing software program, which may be executed by a processor of the electronic device 220 (not shown), so as to interact with the user. As to the hardware elements, one end of the thin line 244 is attached to the fishing rod 242, and the other end of the thin line 244 is attached to the tag 210, such that the user can move the tag 210 by controlling the fishing rod 242. To be more realistic, the tag 210 may be in the shape of fishing bait, such as an earthworm, a small shrimp, or an aquatic plant. Alternatively, the tag 210 may be a thin slice, and the pattern of the bait (an earthworm, a small shrimp, or an aquatic plant) is printed on the thin slice. When the user moves the tag 210 into the detectable range of a camera module 222 of the electronic device 220, the camera module 222 detects and identifies the tag 210 so as to obtain tag information (e.g., by identifying the bait pattern on the tag 210). The processor can control the display device 224 to display a first virtual object 232 and a second virtual object 234 according to the tag information (e.g., the bait pattern). For example, the first virtual object 232 may be the bait pattern or the identified pattern, and the second virtual object 234 may include one or more aquatic organisms related to the first virtual object 232. The fishing software program may further control the display device 224 to show an undersea landscape as a background. When the user moves the fishing rod 242 and the tag 210, the first virtual object 232 (e.g., the bait) moves to follow the movement of the tag 210. When the first virtual object 232 touches the second virtual object 234, the fishing software program may generate, for example, a “getting score” entertainment effect (as follows), and the user can play a fishing simulation game which integrates software elements with hardware elements.

In some embodiments, the electronic device 200 further includes a storage device (not shown) which stores a look-up table. The processor can search the look-up table according to the tag information of the tag 210 and select the corresponding first and second virtual objects 232 and 234. More particularly, when it is determined that the tag 210 has an earthworm-bait pattern, the processor can search for the first and second virtual objects 232 and 234 corresponding to the earthworm-bait pattern in the look-up table. For example, the processor can control the display device 224 to display an earthworm pattern as the first virtual object 232, and a tropical-fish pattern as the second virtual object 234. Alternatively, for example, when the tag information of the tag 210 corresponds to a small-shrimp-bait in the look-up table, the processor can control the display device 224 to display a small-shrimp pattern as the first virtual object 232, and a shark pattern as the second virtual object 234. During the fishing simulation game, the camera module 222 may continuously detect the tag 210. If it is detected that the tag 210 is replaced with a new tag, the camera module 222 will redetect the new tag and obtain new tag information, and the processor will perform the aforementioned display process according to the new tag information.

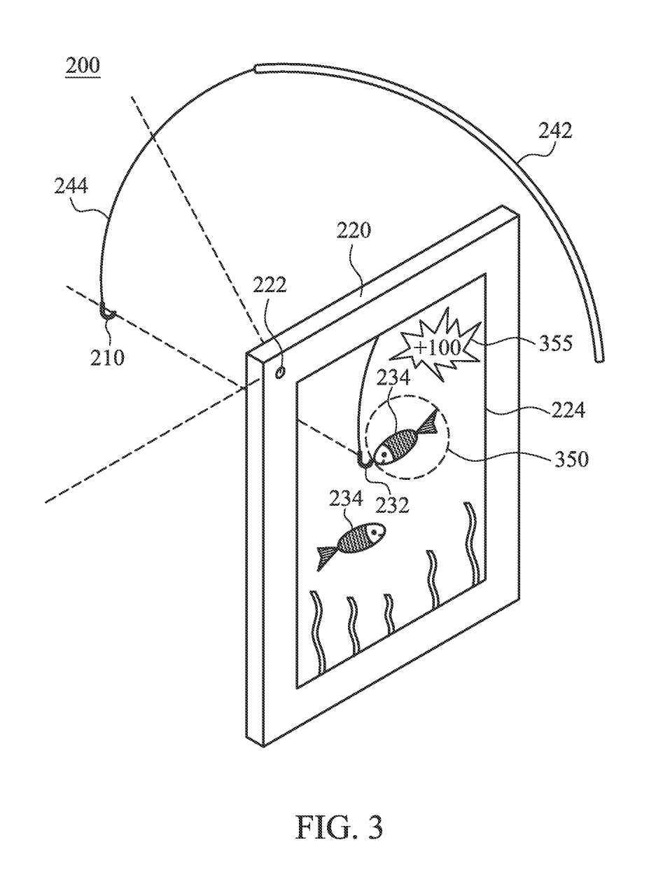

FIG. 3 shows a diagram of the interactive system 200 according to an embodiment of the invention. Following the embodiment of FIG. 2, the fishing simulation game may be operated as follows. When the spacing or distance between the first virtual object 232 (e.g., bait) and the second virtual object 234 (e.g. a fish) is shorter than a predetermined distance (e.g., 2 mm), it may be determined that the first virtual object 232 touches the second virtual object 234 (e.g., the fish eats the bait), and the processor can control the display device 224 to display a score message 355 (e.g., plus 100 points). In some embodiments, the second virtual object 234 has a touch region 350, and the touch region 350 is substantially a circular region surrounding the second virtual object 234. When the first virtual object 232 moves into the touch region 350 of the second virtual object 234, it may be determined that the first virtual object 232 touches the second virtual object 234, and the processor can control the display device 224 to display the score message 355.

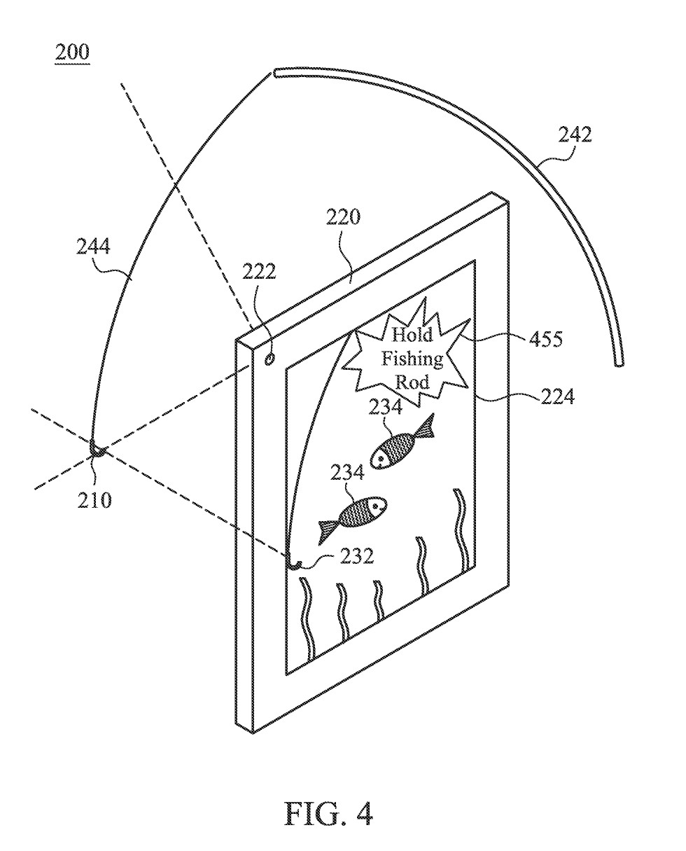

FIG. 4 shows a diagram of the interactive system 200 according to an embodiment of the invention. Following the embodiment of FIG. 2, the fishing simulation game may be operated as follows. When the tag 210 moves outside the detectable range of the camera module 222 or when the first virtual object 232 touches the edge of the display device 224, the processor can control the display device 224 to display a notification message 455 (e.g., hold fishing rod). As a result, the user may adjust the position of the tag 210 and move the tag 210 back to the detectable range of the camera module 222. In some embodiments, when the environmental light is too weak or when the rotation angle of the tag 210 is too great, leading the pattern or the barcode of the tag 210 undetectable, the processor controls the display device 224 to display other notification messages (e.g., increase light, or rotate bait to face the display device 224). As a result, the user may change the environmental factors appropriately. If the problem indicated by the notification message 455 is solved within a predetermined period of time (e.g., 5 seconds), the game will resume its normal state. Conversely, if the problem has continued for more than the predetermined period of time, the game will go back to its initial-settings display.

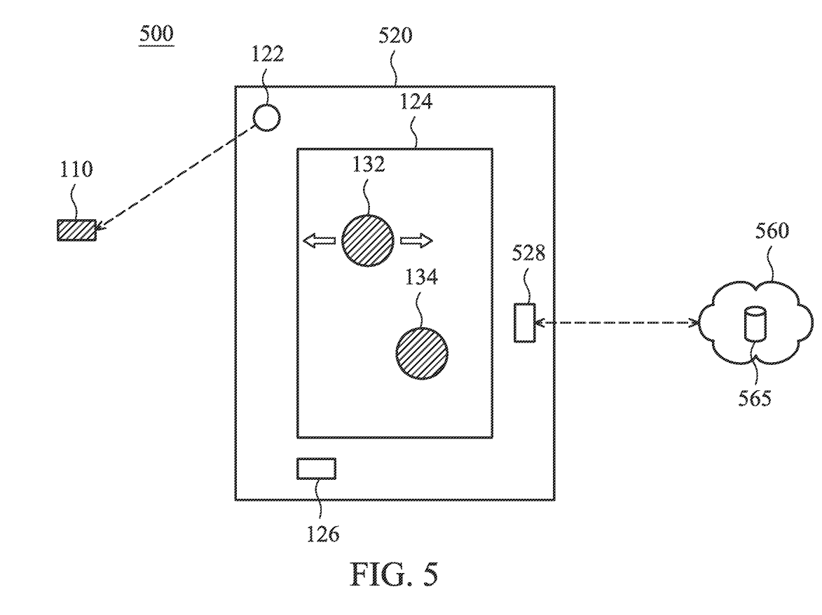

FIG. 5 shows a diagram of an interactive system 500 according to an embodiment of the invention. FIG. 5 is basically similar to FIGS. 1 to 4. In the embodiment of FIG. 5, the interactive system 500 further includes a cloud device 560 (e.g., a server), and an electronic device 520 of the interactive system 500 further includes a network module 528. The cloud device 560 exchanges data through the network module 528 with the electronic device 520 by wireless or wired transmission. When a camera module 122 of the electronic device 520 initially detects a tag 110, the network module 528 can upload tag information of the tag 110 and identification information of the electronic device 520 to the cloud device 560. For example, the identification information of the electronic device 520 may include a hardware serial number of the electronic device 520, a software serial number of the fishing software program, or a user logging account number. This uploading process ties the corresponding tag information of the tag 110 to a specific electronic device, a specific software program, or a specific user, such that other people cannot illegally use the tag 110. More particularly, the uploaded tag information may be compared with a database 565 on the cloud device 560. If the tag information has not been stored in the database 565, the tag information and the identification information will be added into the database 565 for matching. If the tag information has been stored in the database 565, the cloud device 560 will perform an authentication process to the electronic device 520 according to the stored identification information of the electronic device 520, which corresponds to the tag information (e.g., the uploaded identification information may be compared with the identification information stored in the database 565 to check whether they match). If the authentication process succeeds (e.g., the uploaded identification information is consistent with the stored identification information of the database 565), the interactive system 500 will interact normally with the user. If the authentication process fails (e.g., the uploaded identification information is inconsistent with the stored identification information of the database 565), the interactive system 500 will stop interacting with the user. With such a design, a specific tag 110 is only legally authorized to a specific electronic device, a specific software program, or a specific user. This effectively solves the problem of illegal copying and therefore protects the business benefit of developers of the interactive system 500.

In some embodiments, a pattern and a two-dimensional barcode are both formed on the tag 110. For example, the aforementioned pattern may be a bait pattern, and the aforementioned two-dimensional barcode may include UID (Unique Identifier) information of the tag 110. When the electronic device 520 determines that the tag 110 has a bait pattern, the electronic device 520 may search for the first and second virtual objects 232 and 234, which have pattern information corresponding to the bait, in the look-up table. When the electronic device 520 scans and records identification code information of the two-dimensional barcode of the tag 110, the network module 528 may upload the identification code information of the tag 110 and the identification information of the electronic device 520 to the cloud device 560, and the cloud device 560 may perform a matching process (e.g., an initial operation of the uploading process) or an authentication process (e.g., a subsequent operation of the uploading process). The processor may selectively control the display device 224 to display the first and second virtual objects 232 and 234 according to the performed process of the cloud device 560.

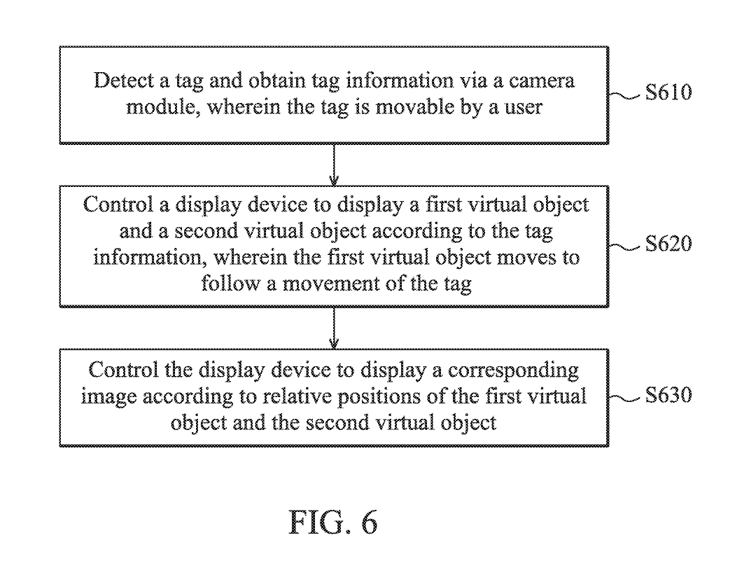

FIG. 6 shows a flowchart of an interactive method according to an embodiment of the invention. The interactive method at least includes the following steps. In step S610, a tag is detected and tag information is obtained via a camera module, and the tag is movable by users. In step S620, a display device is controlled to display a first virtual object and a second virtual object according to the tag information, and the first virtual object moves to follow the movement of the tag. In step S630, the display device is controlled to display a corresponding image according to relative positions of the first virtual object and the second virtual object. Note that any one or more features of the embodiments of FIGS. 1-5 may be applied to the interactive method of FIG. 6.

It is understood that the above fishing simulation game is just exemplary, and the invention is not limited thereto. A designer may apply the invention to other applications, such as a shooting simulation game or a watering simulation game. In such an example, the aforementioned tag may be attached to a physical basketball or a physical water-gun. Furthermore, the aforementioned display device may display a basketball pattern or a water-gun pattern as the first virtual object, and a basket pattern or a potted-plant pattern as the second virtual object.

The interactive system and method of the invention include an electronic device, a software program, and/or a physical element with a tag. By using the invention, a user experiences a variety of highly realistic simulation applications. For example, the invention may be applied to the field of early childhood education to increase hand-eye coordination and mathematical ability among young children. In addition, since the invention is not expensive, it can become popular and have business value.

It is understood that the interactive system and method of the invention are not limited to the configurations of FIGS. 1-6. The invention may merely include any one or more features of any one or more embodiments of FIGS. 1-6. In other words, not all of the features shown in the figures should be implemented in the interactive system and method of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. An interactive system for interaction with a user, comprising:
a tag, wherein the tag is movable by the user; and
an electronic device, comprising:
a camera module, detecting the tag, and obtaining tag information;
a display device; and
a processor, controlling the display device to display a first virtual object and a second virtual object according to the tag information, wherein the first virtual object moves to follow a movement of the tag, and the processor further controls the display device to display a corresponding image according to relative positions of the first virtual object and the second virtual object.

2. The interactive system as claimed in claim 1, wherein the tag information comprises pattern information, and the processor controls the display device to display the first virtual object and the second virtual object according to the pattern information.

3. The interactive system as claimed in claim 1, wherein when distance between the first virtual object and the second virtual object is shorter than a predetermined distance, the processor controls the display device to display a score message.

4. The interactive system as claimed in claim 1, wherein when the tag moves outside a detectable range of the camera module or when the first virtual object touches an edge of the display device, the processor controls the display device to display a notification message.

5. The interactive system as claimed in claim 2, wherein the electronic device further comprises a network module, and the interactive system further comprises:
a cloud device, wherein when the camera module initially detects the tag, the network module uploads the tag information and identification information of the electronic device to the cloud device.

6. The interactive system as claimed in claim 5, wherein the tag information further comprises identification code information.

7. The interactive system as claimed in claim 6, wherein the uploaded identification code information is compared with a database on the cloud device, wherein if the identification code information has not been stored in the database, the identification code information and the identification information of the electronic device are added into the database for matching, and wherein if the identification code information has been stored in the database, the cloud device performs an authentication process according to the identification information of the electronic device.

8. The interactive system as claimed in claim 7, wherein if the authentication process succeeds, the interactive system interacts normally with the user, and wherein if the authentication process fails, the interactive system stops interacting with the user.

9. The interactive system as claimed in claim 8, wherein the tag comprises a pattern, a two-dimensional barcode, a QR code (Quick Response Code), or any combination thereof, and wherein the electronic device obtains the pattern information from the pattern, and the electronic device obtains the identification code information from the two-dimensional barcode or the QR code.

10. An interactive method for interaction with a user, comprising the steps of:
detecting a tag and obtaining tag information via a camera module, wherein the tag is movable by the user;
controlling a display device to display a first virtual object and a second virtual object according to the tag information, wherein the first virtual object moves to follow a movement of the tag; and
controlling the display device to display a corresponding image according to relative positions of the first virtual object and the second virtual object.
